(19) United States
(12) Patent Application Publication
(10) Pub. No.: US 2008/0285281 A1
(43) Pub. Date: Nov. 20, 2008

(54) COMPOSITE ILLUMINATION DEVICE

(75) Inventor: HUA-JUNG CHIU, TAIPEI HSIEN (TW)

Correspondence Address: ROSENBERG, KLEIN & LEE, 3458 ELLICOTT CENTER DRIVE-SUITE 101, ELLICOTT CITY, MD, 21043, US

(73) Assignee: DAVINCI INDUSTRIAL INC., TAIPEI HSIEN (TW)

(21) Appl. No.: 11/749,429

(22) Filed: May 16, 2007

(51) Int. Cl. F21V 21/14

(52) U.S. Cl. 362/250

(57) ABSTRACT

A composite illumination device includes a first casing; at least one first light-emitting element; at least one electric socket and at least one second light unit. The first casing having a receiving space thereinside and the first light-emitting elements are received in the receiving space to emit first light. The second light unit electrically connected to the electric socket to control a second light-emitting element to emit second light. Furthermore, the second light unit is rotatably and movably connected into the electric socket. With the above-mentioned structure, first light is provided for a common illumination and second light can be adjusted to shine a predetermined position for a guiding effect.

### BACKGROUND OF THE INVENTION

1. Field of the Invention

The present invention relates to a composite illumination device, and in particular to an illumination module in which the luminous intensity thereof is changeable.

2. Description of Prior Art

Light-emitting device takes more important parts in the modern society. For example, light-emitting device is provided for illumination so that people can efficiently work in the dark room.

However, according to experiences in practice, there is still a drawback existing in using the single light-emitting element. Because of the arrangement of furniture, there are many dead-corners in room space, such as a bottom of the table or the corner of walls. When the above-mentioned dead corners need to be shined, a user has to move the big and heavy light base to adjust the direction of the light. Therefore, the movement of the light seat is laborious and the user easily gets hurt by some accident.

Therefore, in view of this, the inventor proposes the present invention to overcome the above problems based on his expert experiences and deliberate researches.

### SUMMARY OF THE INVENTION

The primary object of the present invention is to provide a composite illumination device, which provides a multi-lighting effect having a common illumination and an adaptive illumination.

The other object of the present invention is to provide a composite illumination device. The composite illumination device has a rapid-acting coupling so that the second light unit is fast and efficiently assembled or disassembled with the first casing.

In order to achieve the above objects, the present invention provides a composite illumination device comprising: a first casing; at least one first light-emitting element; at least one electric socket and at least one second light unit. The first casing having a receiving space thereinside and the first light-emitting elements are received in the receiving space to emit first light. The second light unit electrically connected to the electric socket to control a second light-emitting element to emit second light. Furthermore, the second light unit is rotatably and movably connected into the electric socket.

In order to achieve the above objects, the present invention provides a composite illumination device comprising: a first casing, a first light-emitting element, a control circuit assembly and a second light unit. The first casing having a receiving space thereinside and the first light-emitting elements are received in the receiving space to emit first light. The control circuit assembly is disposed inside the first casing, and the control circuit assembly has an electric socket disposed on a surface of the first casing. The second light unit has a connecting pin and a second light-emitting element for emitting second light, and the connecting pin is electrically connected with the second light-emitting element and is used to be inserted into the electric socket for electrically connecting with a power supply.

The first light-emitting element is a fluorescent lamp or a LED set, and the second light-emitting element is a LED to lower consumption of electricity.

The present invention has the following effects. The second light unit is rotatably and movably connected with the electric socket on the first casing, so that a user can adjust the direction of the second light and project light on a predetermined position. Thus, the illumination device is friendly-used for a person to change the direction of the light by rotating the second light unit instead of moving the first casing laboriously. Further, the connection as a rapid-acting coupling is employed between the second light unit and the first casing so that it is convenient to assemble or disassemble the second light unit on the first casing.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is an assembled view showing the first embodiment of the present invention;

FIG. 2 is an exploded perspective view showing the first embodiment of the present invention; and

FIG. 3 is an exploded perspective view showing the second embodiment of the present invention.

### DETAILED DESCRIPTION OF THE INVENTION

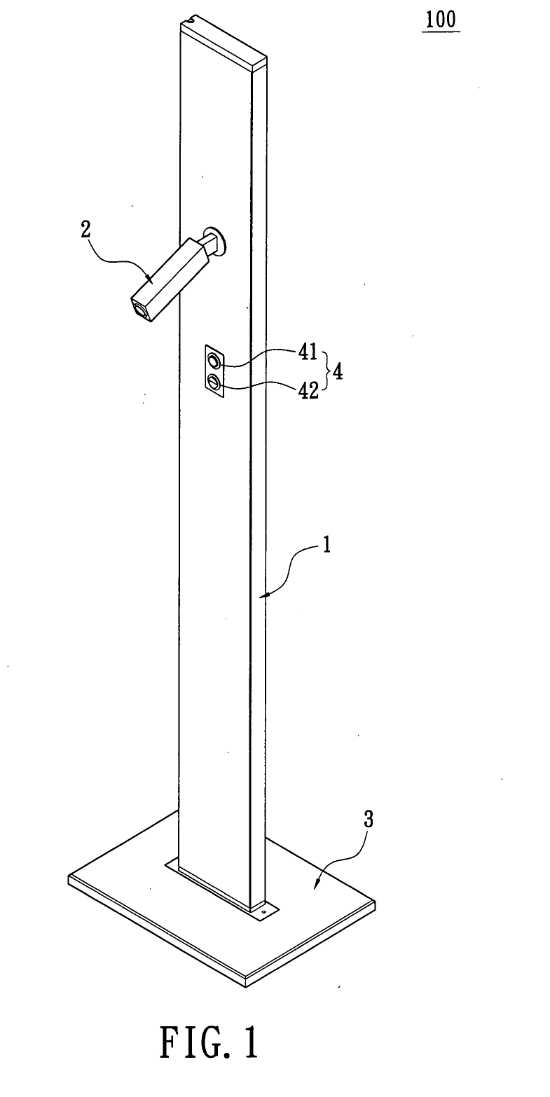

With reference to FIG. 1, it shows the first embodiment of the present invention. The present invention provides a composite illumination device 100, which comprises a first casing 1; a second light unit 2; a base 3 and two switches 4. The first casing 1 is vertically mounted on the base 3, and the base 3 contacts with a surface, such as a ground. Alternatively, the bas 3 can be fixed on a wall or a ceiling for setting the composite illumination device 100 on a predetermined position (not shown).

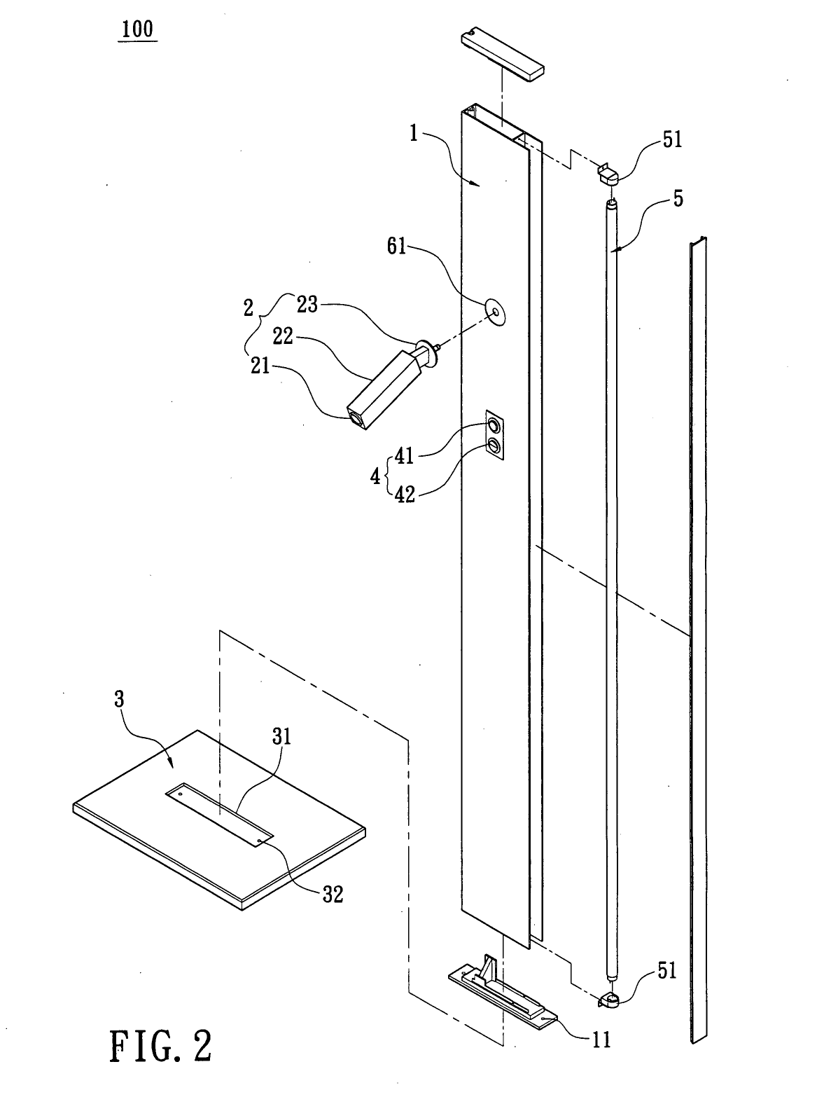

Please refer to FIG. 2, first casing 1 has a receiving space thereinside and at least one first light-emitting element 5 is received in the receiving space. In the first embodiment, the first light-emitting element 5 is a fluorescent lamp with T5 specification. Each end of the first light-emitting element 5 is electrically connected with a connector 51 and the two connectors 51 are respectively fixed inside the first casing 1. The first light-emitting element 5 provides as a common illumination for emitting first light in entire space, i.e. the first light is not limited in some specific directions. The first casing 1 is preferably made of transparent materials allowing the first light to pass through. Alternatively, at least one side of the first casing 1 is transparent for the first light passing through.

At least one electric socket 61 is disposed on a surface of the first casing 1 and the electric socket 61 connects electrically to household electric power (not shown). In detail, the composite illumination device 100 is provided with a control circuit assembly to control the light generation. The control circuit assembly is disposed inside the first casing 1 (not shown) and connects electrically to a power supply such as household electric power (not shown). The electric socket 61 and the connectors 51 are respectively connected to the control circuit assembly. Furthermore, the control circuit assembly comprises conductive wires, electronic devices and at least one printed circuit board (PCB). The conductive wires and electronic devices are disposed on the PCB for electrically connection (not shown). The second light unit 2 is rotatably and movably inserted into the electric socket 61. The second light unit 2 has a second light-emitting element 21 thereinside and when the second light unit 2 is inserted into the electric socket 61 to connect electrically with a power supply such as the house-hold electric power, the second light-emitting element 21 can emit a second light. In detail, the second light unit 2 has a body portion 22 and a connecting portion 23. The second light-emitting element 21 is received in the body portion 22 and connected electrically with the connecting portion 23. The body portion 22 is pivoted with the connecting portion 23. The connecting portion 23 is used for being inserted into the electrical socket 61 and the connecting portion 23 is preferably formed of a connecting pin. When the connecting portion 23 is inserted into the electrical socket 61, the second light-emitting element 21 emits a second light. Because of the inserted mechanism and the pivoted connection, it's convenient for a user to rotate and adjust the angle of the second light unit 2. In other words, the direction of the second light is adjustable for projecting second light on predetermined positions depending on a control of the user. Accordingly, the second light has a guiding effect to shine a predetermined position in any angles and an adaptive illumination is achieved.

Furthermore, the second light unit 2 and the electric socket 61 are assembled as a rapid-acting coupling. The connecting portion 23 is preferable a connecting pin for being inserted into the electric socket 61. The connecting portion 23 and the electric socket 61 are respectively act as a male head of the rapid-acting coupling and a female head of rapid-acting coupling so that they are easily and fast assembled and disassembled. A user can easily inserts a second light unit 2 into the electric socket 61 for powering the second light unit 2 to emit second light. As above-mentioned, the second light unit 2 has a second light-emitting element 21 thereinside and the second light-emitting element 21 is preferable a LED. Thus, a user can prepare a plurality of the second light units 2 and each second light unit 2 respectively has a LED that emits different colors from another second light unit 2. The second light units 2 are respectively inserted into the electric socket 61 to emit second light of different colors. In other words, a user can rapidly and easily replace the second light unit 2 for another second light unit 2 in order to change the color of the second light. Alternatively, more than one electric sockets 61 can be disposed on the surface of the first casing 1 and the electric sockets 61 are provided for connecting with the second light units 2 to illuminate with different colors. Accordingly, the present invention provides a multi-lighting effect having a common illumination and an adaptive illumination.

On the other hand, at least one switch 4 is disposed on the surface of the first casing 1 and each switch 4 is electrically connected with a corresponding light-emitting element. In this embodiment, two switches 41 and 42 are disposed on the surface of the first casing 1. The switch 41 is electrically connected with the first light-emitting element 5. The switch 41 controls the on/off sate of the first light-emitting element 5 and preferably, the switch 41 can adjust the brightness of the first light-emitting element 5. Similarly, the switch 42 is connected electrically with and controls the second light-emitting element 21.

A recess 31 is defined on the base 3 and the shape of the recess 31 is corresponding to the shape of the first casing 1. In other words, the first casing 1 is received in the recess 31 so that the first casing 1 can be vertically mounted on the base 3. A plurality of fixing hole 11 are defined on the bottom surface, and a plurality of connecting holes 32 are defined on the base 3 corresponding to the fixing holes 11. By driving a screw into the corresponding fixing hole 11 and the connecting hole 32, the first casing 1 are firm fixed on the base 3.

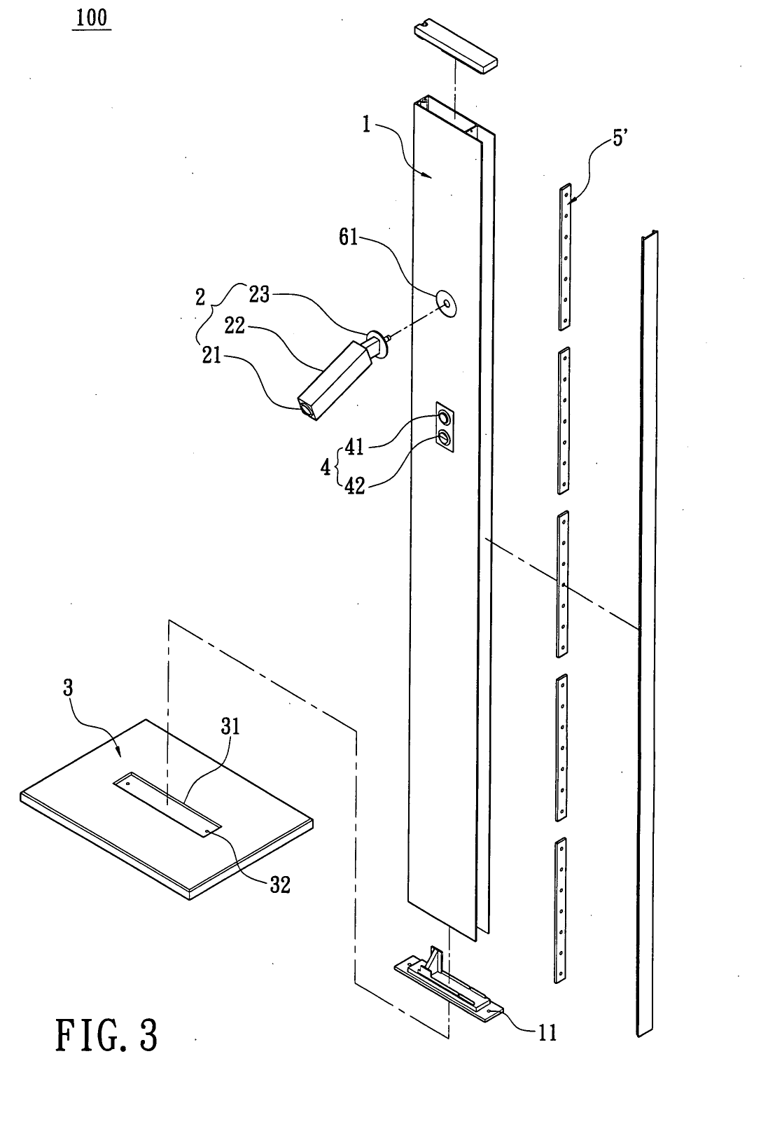

Please refer to FIG. 3, the second embodiment of the present invention is shown. As illustrated, the light-emitting element 5′ comprises a plurality of LEDs. The LEDs are directly connected with the control circuit assembly in order to be applied for electricity. Due to the characteristics of LED, the composite illumination device 100 saves more power. Similarly, a user can adjust the direction of the second light to shine a predetermined position. Moreover, the second light unit 2 can be efficiently assembled or disassembled with the electric socket 61.

Depending on the above, the present invention utilizes a second light unit 2 that can be inserted into the electric socket 61 to emit a second light. The first light-emitting element 5 is used to emit a first light as a common illumination. However, there are some objects or furniture in the room to block the common illumination. A user can easily adjust the second light to shine on predetermined positions. Accordingly, the composite illumination device provides for an adaptive illumination with multiple functions. Furthermore, the composite illumination device provides for an illumination system that provides a guiding illumination with low consumption of electricity.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A composite illumination device, comprising:
a first casing having a receiving space thereinside;
at least one first light-emitting element received in the receiving space to emit first light;
at least one electric socket disposed on a surface of the first casing; and
at least one second light unit having a second light-emitting element thereinside wherein the second light unit is electrically connected to the electric socket to control the second light-emitting element to emit second light;
wherein each second light unit is rotatably and movably connected to the electric socket, and the second light unit and the electric socket are assembled together as a rapid-acting coupling;
whereby the second light unit is provided for adjusting a direction of the second light and the second light unit is fast and rapidly assembled/disassembled with the electric socket.

2. The composite illumination device according to claim 1, further comprising at least one switches disposed on the surface of the first casing, wherein the switches are electrically connected with the first light-emitting element and the second light-emitting element.

3. The composite illumination device according to claim 2, wherein the switches respectively control the first and the second light-emitting elements to emit the first and the second light.

4. The composite illumination device according to claim 1, wherein each second light unit comprises a body portion and a connecting portion, and the second light-emitting element is received inside the body portion and electrically connected with the connecting portion.

5. The composite illumination device according to claim 4, wherein the connecting portion is inserted into the electric socket and the body portion is pivotedly connected with the connecting portion.

6. The composite illumination device according to claim 1, wherein the first light-emitting element is a fluorescent lamp.

7. The composite illumination device according to claim 6, wherein the fluorescent lamp is a T5 lamp.

8. The composite illumination device according to claim 1, wherein the first light-emitting element comprises a plurality of light emitting diodes (LEDs).

9. The composite illumination device according to claim 1, wherein each second light-emitting element is a light emitting diode (LED).

10. The composite illumination device according to claim 1, further comprising a base, wherein the first casing is vertically mounted on the base.

11. A composite illumination device, comprising:
a first casing;
a first light-emitting element received inside the first casing for emitting first light;
a control circuit assembly disposed inside the first casing, wherein the control circuit assembly has an electric socket disposed on a surface of the first casing; and
a second light unit having a connecting pin and a second light-emitting element for emitting second light, wherein the connecting pin is electrically connected with the second light-emitting element and is used to be inserted into the electric socket;
wherein the second light unit is rotatably and movably connected with the first casing via the insertion of the connecting pin.

12. The composite illumination device according to claim 11, wherein the control circuit assembly further comprises a plurality of switches disposed on the surface of the first casing, and the switches control respectively the first and the second light-emitting elements to emit the first and the second light.

13. The composite illumination device according to claim 11, wherein the first light-emitting element is a fluorescent lamp.

14. The composite illumination device according to claim 13, wherein the fluorescent lamp is a T5 lamp.

15. The composite illumination device according to claim 11, wherein the first light-emitting element comprises a plurality of light emitting diodes (LEDs).

16. The composite illumination device according to claim 11, wherein the second light-emitting element is a light emitting diode (LED).

17. The composite illumination device according to claim 11, further comprising a base, wherein the first casing is vertically mounted on the base.

18. The composite illumination device according to claim 11, wherein the control circuit assembly is electrically connected with a power supply.
